(19) United States
(12) Patent Application Publication
(10) Pub. No.: US 2022/0135493 A1
(43) Pub. Date: May 5, 2022

(54) METHOD FOR PRODUCING ORGANIC FERTILIZER ENABLING INCREASED MICROBIAL DIVERSITY AND ABUNDANCE IN SOIL, AND USE OF THE ORGANIC FERTILIZER

(71) Applicant: Tarim University, Ala'er City (CN)

(72) Inventors: Hong ZENG, Ala'er City (CN); Lingqi HUA, Ala'er City (CN); Chang GAO, Ala'er City (CN); Guimin LIU, Ala'er City (CN)

(21) Appl. No.: 17/483,432

(22) Filed: Sep. 23, 2021

(30) Foreign Application Priority Data
Nov. 5, 2020 (CN) 202011222062.9

(51) Int. Cl. C05F 11/08; C05F 3/00; C05F 5/00; A01C 21/00

(52) U.S. Cl. CPC C05F 11/08; A01C 21/00; C05F 5/002; C05F 3/00

(57) ABSTRACT

A method for producing an organic fertilizer enabling an increased microbial diversity and abundance in soil, and use of the organic fertilizer are provided. The method comprises composting fresh S. alopecuroides plants together with sheep and/or goat manure through anaerobic fermentation. It is found through experiments that, by applying the organic fertilizer produced by the method to a soil in which melon plants are grown, both abundance of bacterial and fungal communities in the rhizosphere of the plants and contents of soluble solids and sugar in fruit of the plants are increased. By a combination of taxonomic composition of the microbial communities in the rhizosphere and RDA analysis, it is further found that abundance of multiple bacterial and fungal species conducive to growth and disease resistance of the plants, is substantially increased and positively correlated with the soluble solids and sugar contents in the fruit.

### CROSS REFERENCE TO RELATED APPLICATION

This patent application claims the benefit and priority of Chinese Patent Application No. 202011222062.9 filed on Nov. 5, 2020, the disclosure of which is incorporated by reference herein in its entirety as part of the present application.

### TECHNICAL FIELD

The present disclosure is related to the field of organic fertilizers, and in particular to a method for producing an organic fertilizer which enables an increased microbial diversity and abundance in soil, and use of the organic fertilizer.

### BACKGROUND ART

Sophora alopecuroides L. (S. alopecuroides), also called Kudouzi in China, is a common plant in Northwest China. In China's Xinjiang region, traditionally, S. alopecuroides plants at full bloom are harvested and applied as an organic fertilizer to the soil near roots of a melon plant, such as watermelon and muskmelon (Cucumis melo, also known as melon), to enhance the sweetness of its fruit.

As well known, there is a great demand for mutton and beef in Xinjiang, and livestock husbandry in this region is well developed. Manure produced by sheep and/or goat is often applied to soil after being fermented and composted. The manure can improve quality and fertility of the soil. Accordingly, use of chemical fertilizers may be prevented or at least reduced.

The goal of achieving an efficient binding of S. alopecuroides and the manure to produce a good organic fertilizer, that can replace the chemical fertilizers, has been the focus of study for many years.

### SUMMARY

Therefore, an objective of the present disclosure is to provide a method for producing an organic fertilizer from S. alopecuroides and sheep and/or goat manure, which enables an increased microbial diversity and abundance in soil, and use of the organic fertilizer.

Accordingly, one objective of the present disclosure is realized by a method for producing an organic fertilizer, comprising:

composting fresh S. alopecuroides plants together with sheep and/or goat manure by making a heap thereof with a layer of the manure disposed on a layer of the plants and then moistening all layers with water and covering the heap with a polymeric film to allow for anaerobic fermentation in a sealed environment,

wherein, the fermentation is determined to be completed when the following conditions are satisfied: the temperature of the heap decreases; odor from the manure, sulfur, and ammonia disappears; a scent peculiar to the S. alopecuroides plants is emitted; the colour becomes light and changes to brown; and leaves of the plants are degraded and remaining stalks are dark in colour and have soft and frangible fibers.

A mass ratio of the S. alopecuroides plants to the manure may be 1000:300.

The anaerobic fermentation may be carried out for 40 days.

Another objective of the present disclosure is realized by use of the organic fertilizer produced according to the method as described above, comprising application of the organic fertilizer to a soil in which a plant is grown at the end of the flowering period of the plant to increase abundance of bacterial and fungal communities in the rhizosphere of the plant.

The bacterium may be selected from the group consisting of Saccharimonadales, Haliangium, Iamia, Pelomonas, Pedomicrobium, Gaiella, Rokubacteriales, Lysobacter, and Acinetobacter.

The fungus may be selected from the group consisting of Acremonium, Lophotrichus, Aspergillus, Mortierella, Botryotrichum, Pseudeurotium, Acaulium, Ilyonectria, Cutaneotrichosporon, and Talaromyces.

A further objective of the present disclosure is realized by use of the organic fertilizer produced according to the method as described above, comprising application of the organic fertilizer to a soil in which a melon plant is grown at the end of the flowering period of the melon plant to increase contents of soluble solids and sugar present in fruit of the plant.

The present disclosure may provide several advantages. The present inventors have found through experiments that, by applying the organic fertilizer produced by the present method to a soil in which melon plants are grown, growth and propagation of beneficial bacteria species in the rhizosphere of the melon plants can be facilitated, and their relative abundance can thus be increased. It has also been found that the abundance of the beneficial bacteria is positively correlated with the contents of soluble solids and sugar in fruit of the melon plants. These findings, together with the taxonomic composition of the bacterial and fungal communities in the rhizosphere, suggest that the organic fertilizer can cause the microbial community structure in the rhizosphere, in particular the bacterial and fungal community compositions and their functions, to be changed, facilitate growth of beneficial bacteria, and increase the contents of soluble solids and sugar in fruit of the plants.

### BRIEF DESCRIPTION OF THE DRAWINGS

FIG. 1A is a bar chart showing a comparison of the soluble solids content in melon flesh samples between the experimental groups of melon varieties M1, M2, and M27 treated with the organic fertilizer prepared in Example 1 and the control groups;

FIG. 1B is a bar chart showing a comparison of the sugar content in melon flesh samples between the experimental groups of melon varieties M1, M2, and M27 treated with the organic fertilizer prepared in Example 1 and the control groups;

FIG. 2 shows box-plots illustrating bacterial alpha diversity in the rhizosphere samples in the treatment and control groups of melon varieties M1, M2, and M27;

FIG. 3 shows box-plots illustrating fungal alpha diversity in the rhizosphere samples in the treatment and control groups of melon varieties M1, M2, and M27;

FIG. 4 shows a heat map of the bacterial genera in the rhizosphere samples in the treatment and control groups of melon varieties M1, M2, and M27;

FIG. 5 shows a heat map of the fungal genera in the rhizosphere samples in the treatment and control groups of melon varieties M1, M2, and M27;

FIG. 6A shows Non-metric Multidimensional Scaling (NMDS) analysis of the bacterial communities in the rhizosphere samples in the treatment and control groups of melon varieties M1, M2, and M27;

FIG. 6B shows NMDS analysis of the fungal communities in the rhizosphere samples in the treatment and control groups of melon varieties M1, M2, and M27;

FIG. 7A shows Redundancy Analysis (RDA) of the soluble solids and sugar contents in melon flesh samples, and environmental factors, biological factors, and bacterial communities in the rhizosphere samples; and

FIG. 7B shows RDA analysis of the soluble solids and sugar contents in melon flesh samples, and environmental factors, biological factors, and fungal communities in the rhizosphere samples.

### DETAILED DESCRIPTION OF THE EMBODIMENTS

### Example 1—Preparation of an Organic Fertilizer from S. Alopecuroides and Sheep Manure

Fresh S. alopecuroides plants and sheep manure with a mass ratio of 1000:300 were used as starting materials. A heap of the materials was first made with a layer of the manure disposed on a layer of the plants. Then, all layers were moistened with water. The moistened heap was covered with a polymeric film to allow for anaerobic fermentation in a sealed environment.

After 40 days, it was found that the temperature of the heap decreased; odor from the manure, sulfur, and ammonia disappeared; a scent peculiar to the S. alopecuroides plants was emitted; the colour became light and changed to brown; and leaves of the plants were degraded and remaining stalks were dark in colour and had soft and frangible fibers. These indicated the completion of the fermentation, and a compost heap, also referred to herein as an organic fertilizer, was thus obtained based on S. alopecuroides and sheep manure.

### Example 2—Effect of the Organic Fertilizer on Microbial Community Structure in the Rhizosphere of Melon Plants

Field experiments were conducted in a greenhouse of 10^{th} Regiment of 1^{st} Agricultural Division of Xinjiang Production and Construction Corps from June to October in 2019. The greenhouse soil is sandy soil with medium fertility, and the irrigation is good. Seeds of melon varieties M1, M2, and M27 were sown on June 2. Seedlings were transplanted to the greenhouse soil for cultivation with plastic mulching on July 2 when they reached the third or fourth true leaf stage. In cultivation, the seedlings were planted in two rows in one big ridge.

At the end of the flowering period of the melon plants, a portion of them was treated with the organic fertilizer prepared in Example 1 by applying the fertilizer to the soil (experiment or treatment group, T), and another portion of them was not treated with the fertilizer (control group, C).

Rhizosphere soils of the plants in the treatment and control groups were sampled and analyzed for physical and chemical properties and enzyme activities. The results are shown in Tables 1 and 2 below. From Table 1, it can be seen that the contents of ammonium nitrogen, and rapid available phosphorus and potassium present in the rhizosphere samples in the treatment groups were substantially the same as those in the control groups. From Table 2, it can be seen that the activities of urease (UE), sucrase (SC), alkaline phosphatase (ALP/AKP), alkaline protease (ALPT), catalase (CAT), and polyphenol oxidase (PPO) in the rhizosphere samples in the treatment groups were also substantially the same as those in the control groups.

TABLE 1

| | | K⁺/ | P³⁺/ | N—MH₄⁺/ |
|---|---|---|---|---|
| Sample | | (mg/kg) | (mg/kg) | (mg/kg) |
| M1 | C | 42.6667 ± 0.57735 | 5.9355 ± 3.10863 | 4.5517 ± 1.95209 |
| | T | 57.3333 ± 2.30940 | 6.7429 ± 2.97870 | 3.8667 ± 1.19061 |
| M2 | C | 57.0000 ± 2.64575 | 4.4095 ± 2.44561 | 4.1982 ± 0.51548 |
| | T | 61.6667 ± 4.50925 | 5.5202 ± 3.42579 | 4.2832 ± 1.71125 |
| M27 | C | 63.0000 ± 1.73205 | 3.0500 ± 1.44705 | 3.2666 ± 0.19007 |
| | T | 56.6667 ± 2.88675 | 2.0009 ± 2.98687 | 2.1536 ± 1.18974 |

TABLE 2

| | | | | | S-AKP/ALP | S-UE/ | S-SC/ |
|---|---|---|---|---|---|---|---|
| Sample | | S-PPO/(mg/d/g) | S-CAT/(μmol/d/g) | S-ALPT/(mg/d/g) | (μmol/d/g) | (mg/d/g) | (μmol/d/g) |
| M1 | C | 87.7760 ± | 33.5024 ± | 15.2678 ± | 9.0633 ± | 0.3209 ± | 32.3151 ± |
| | | 1.59674 | 1.83892 | 16.68083 | 2.01522 | 0.01406 | 4.29391 |
| | T | 90.6144 ± | 33.9153 ± | 25.6198 ± | 11.0616 ± | 0.3294 ± | 37.4564 ± |
| | | 3.96489 | 4.87664 | 15.53673 | 1.13980 | 0.02576 | 5.40332 |
| M2 | C | 95.6571 ± | 33.1240 ± | 24.1964 ± | 6.5619 ± | 0.3647 ± | 32.9280 ± |
| | | 9.87988 | 1.30146 | 7.23848 | 1.14147 | 0.07243 | 6.77811 |
| | T | 93.4725 ± | 32.8411 ± | 21.9426 ± | 1.8728 ± | 0.3404 ± | 35.6667 ± |
| | | 4.72373 | 1.38875 | 4.41757 | 5.10111 | 0.05096 | 5.23533 |
| M27 | C | 96.0603 ± | 33.0924 ± | 27.8842 ± | 5.4851 ± | 0.2823 ± | 35.5679 ± |
| | | 4.70065 | 0.50867 | 4.93869 | 2.23862 | 0.04067 | 4.64257 |
| | T | 98.3707 ± | 29.2449 ± | 18.3091 ± | 6.5850 ± | 0.2913 ± | 19.3342 ± |
| | | 2.03658 | 2.07237 | 1.33217 | 1.41270 | 0.01988 | 2.17249 |

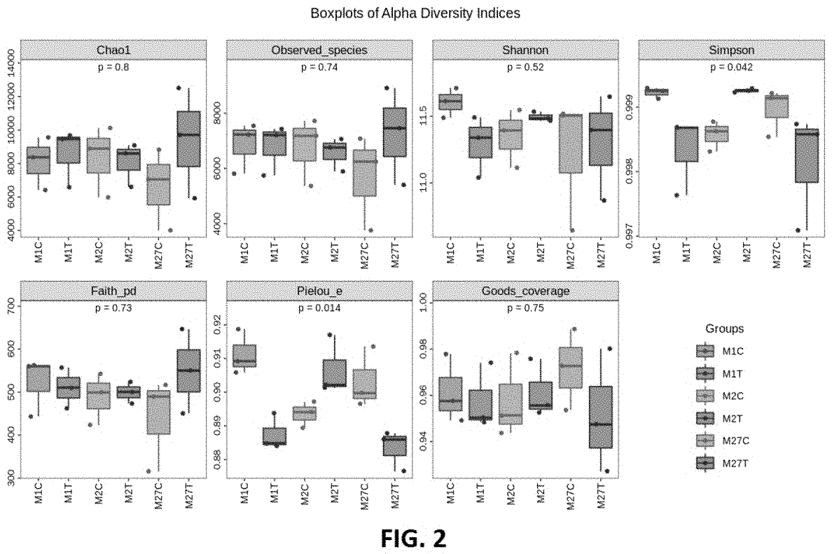

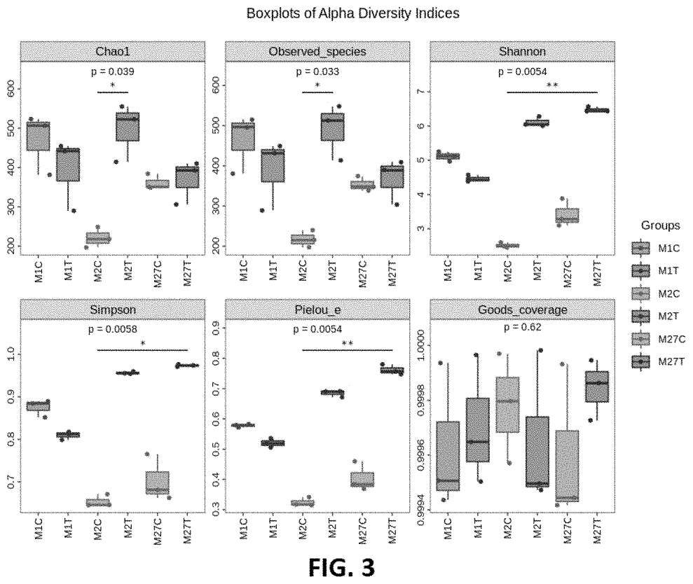

The above rhizosphere samples were further analyzed for the bacterial diversity therein. The results show that, among the bacterial alpha diversity indices, the Chao 1 index was higher in the treatment groups of M1 and M27 than in the respective control groups, as shown in FIG. 2. This indicates an increased bacterial community abundance in the rhizosphere, which has been found to be helpful for maintaining health of the plants. Also, among the fungal alpha diversity indices, the Chao 1 and shannnon indexes were higher in the treatment groups of M2 and M27 than in the respective control groups, as shown in FIG. 3. This indicates an increased fungal community abundance and diversity in the rhizosphere.

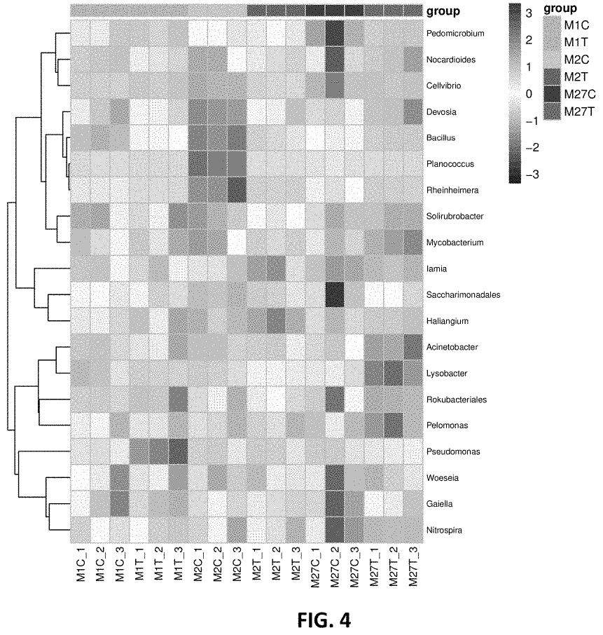

From the above results of the bacteria and by a comparison of the taxonomic composition of the bacterial communities in the rhizosphere samples between the treatment and control groups of M1, M2 and M27, it was further found that the abundance of the bacteria genera Acinetobacter, Iamia (Actinomycete), Pelomonas (family Burkholderiaceae), Lysobacter (phylum Proteobacteria) and Streptomyces in the rhizosphere samples in the treatment groups was substantially increased, as shown in FIG. 4.

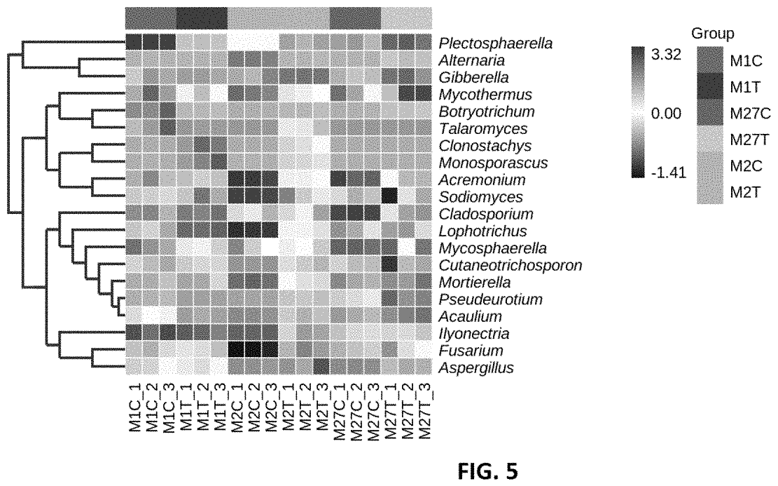

From the above results of the fungi and by a comparison of the taxonomic composition of the fungal communities in the rhizosphere samples between the treatment and control groups of M1, M2 and M27, it was found that the abundance of the fungal genera Mortierella, Aspergillus, Cutaneotrichosporon, Ilyonectria, Mycosphaerella, Chaetomium, Trichothecium, Stachybotrys, Fusarium, Vishniacozyma, Penicillium, and Podosphaera in the rhizosphere samples in the treatment groups was substantially increased, as shown in FIG. 5.

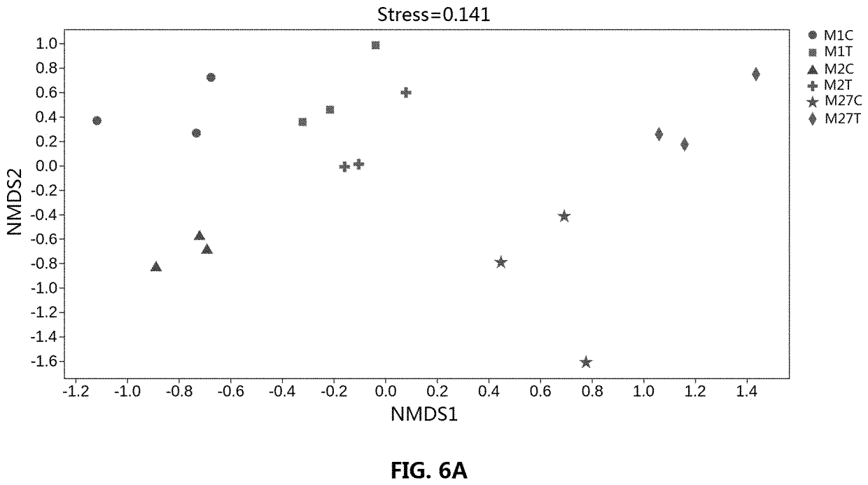

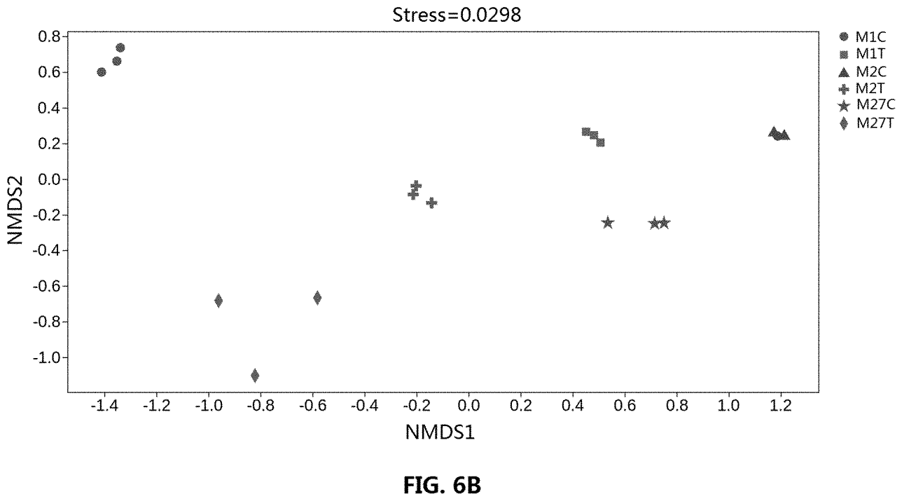

Non-metric Multidimensional Scaling (NMDS) analysis of the bacterial (FIG. 6A) and fungal (FIG. 6B) communities in the rhizosphere samples in the treatment and control groups of melon varieties M1, M2, and M27 showed that the application of the organic fertilizer resulted in a change of the microbial community structure in the rhizosphere, in particular, change of the bacterial and fungal community compositions and their functions.

### Example 3—Effect of the Organic Fertilizer on Fruit Sweetness

When the fruit of the melon plants in Example 2 had ripened, its flesh was sampled and measured for the soluble solids and sugar contents.

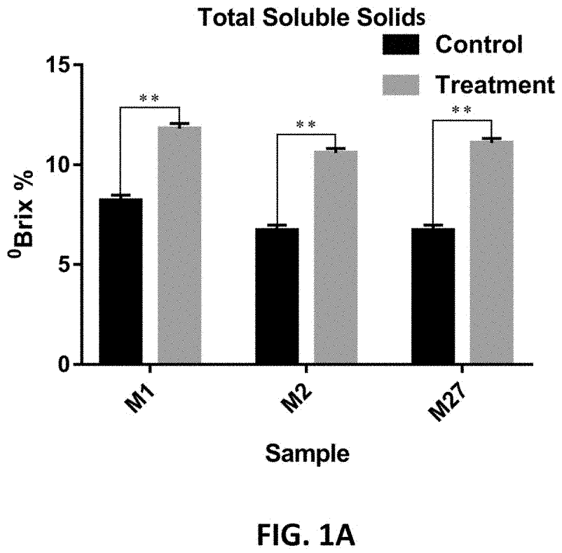

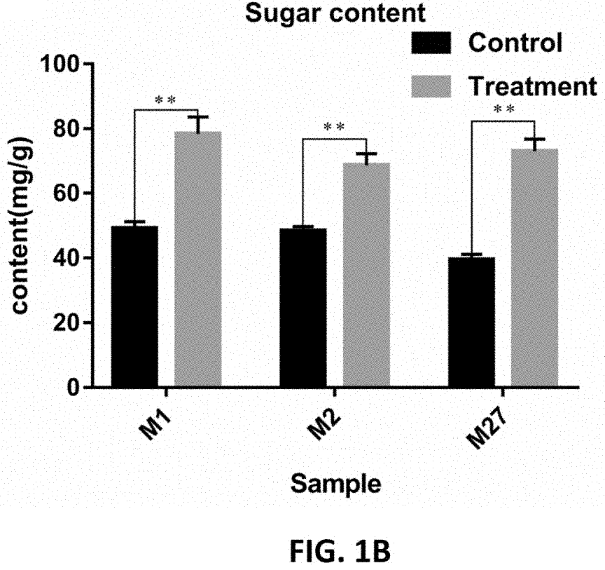

The results are shown in FIGS. 1A and 1B. The figures show that the contents of the soluble solids and sugar in the flesh samples in the treatment groups of M1, M2, and M27 were substantially higher than those in the respective control groups. In particular, the average soluble solids content of the treatment groups of M1, M2, and M27 were 11.8, 10.6, and 11.1%, respectively; while the average soluble solids content of the control groups of M1, M2, and M27 were 8.2, 6.7, and 6.7%, respectively. The average sugar content of the treatment groups of M1, M2, and M27 were 78.4, 68.7, and 73.0 mg·g⁻¹, respectively; while the average sugar content of the control groups of M1, M2, and M27 were 49.1, 48.4, and 39.5 mg·g⁻¹. These indicate that the application of the organic fertilizer can improve the sweetness level of the fruit.

The effects of the organic fertilizer on the soil and the fruit, as described in Examples 2 and 3, were further analyzed, as follows.

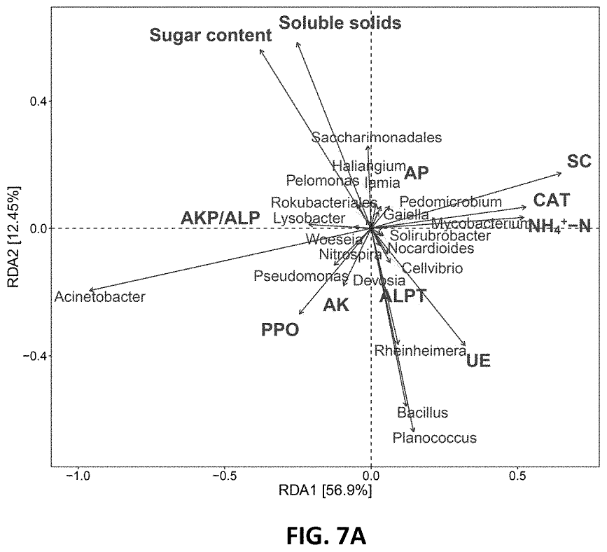

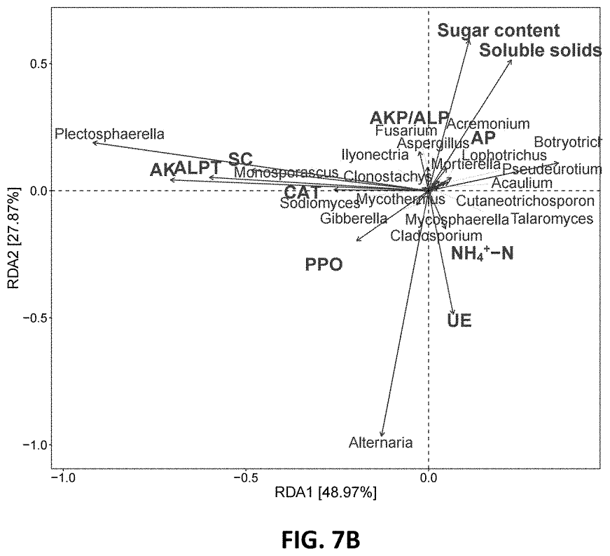

Redundancy Analysis (RDA) was performed to study the relationship between the soluble solids and sugar contents in the fruit and the environmental and biological factors in the soil. The results are shown in FIGS. 7A and 7B. From the figures, it can be seen that:

1) the available phosphorus content in the rhizosphere was positively correlated with the sugar content in the fruit;

2) the alkaline phosphatase activity in the rhizosphere was positively correlated with the sugar content in the fruit;

3) the abundance of bacteria Saccharimonadales, Haliangium, Iamia, Pelomonas, Pedomicrobium, Gaiella, Rokubacteriales, Lysobacter, and Acinetobacter in the rhizosphere was positively correlated with the sugar content in the fruit; and

4) the abundance of fungi Acremonium, Lophotrichus, Aspergillus, Mortierella, Botryotrichum, Pseudeurotium, Acaulium, Ilyonectria, Cutaneotrichosporon, and Talaromyces in the rhizosphere was positively correlated with the sugar content in the fruit.

By a combination of the taxonomic composition of the microbial communities in the rhizosphere and the RDA analysis, it was further found that the abundance of multiple bacterial and fungal species of the treatment groups, which are conducive to the growth and disease resistance of the plants, was substantially increased and was positively correlated with the soluble solids and sugar contents in the fruit. The multiple bacterial species included bacteria Pseudomonas, Bacillus, Burkholderia, Streptomyces, Acinetobacter, Proteobacteria, Lysobacter, and Actinomycete. Pseudomonas may produce siderophores to promote plant growth, and also produce antifungal antibiotics to inhibit growth of plant pathogenic fungi. Bacillus may synthesize auxin (IAA) to promote plant growth, and produce bacterial endospores and various biologically active compounds. Burkholderia can promote plant growth via biological nitrogen fixation, and have also been reported to have a dissolution capability for phosphates. Streptomyces can promote plant growth via production of siderophores and synthesis of 3-indoleacetic acid as well as production of dextranase which may inhibit growth of plant pathogenic fungi. Acinetobacter may produce phosphates via dissolution of soil minerals, ACC deaminase and IAA to promote plant growth, and also exhibit antifungal activity. A large group of Proteobacteria has been found to have an antagonist effect on pathogenic bacteria. Lysobacter may synthesize glucanase to inhibit growth of fungi. Actinomycete, as a major microbial species of antibiotic origin, can not only produce antibiotics to inhibit growth of pathogenic bacteria, but also synthesize and secrete chitinase, protease, and cellulase to kill pathogenic fungi and provide nutrition to the plants.

The multiple fungal species included Penicillium, Aspergillus, and Fusarium. Penicillia are often enriched in soil and have resistance to some diseases. Some strains of penicillia have been proven to have antagonistic activities to fungi, and are usually used as a biological control agent in the composting process. Aspergillus may produce antibiotics to prevent pathogen growth. At a later stage of plant growth, Fusarium species, which often causes blight disease in the plants, can cause severe invasive infections in plants. Advantageously however, propagation of beneficial rhizobacteria resulted in by the present organic fertilizer enhanced the resistance of the plants to this type of pathogenic bacteria.

In summary, the organic fertilizer prepared in Example 1 facilitated growth and propagation of beneficial bacteria species in the rhizosphere of the melon plants and increased their relative abundance. The relative abundance of the beneficial bacteria in the rhizosphere was positively correlated with the contents of the soluble solids and sugar present in fruit of the melon plants. Further, the present organic fertilizer caused the microbial community structure in the rhizosphere, in particular the bacterial and fungal community compositions and their functions, to be changed, facilitated the growth of the beneficial bacteria, and also caused increased contents of the soluble solids and sugar in the fruit.

The description of the present disclosure has been presented for purposes of illustration, but is not intended to be exhaustive or to limit the scope of the disclosure. Many modifications and variations will be apparent to those of ordinary skill in the art without departing from the scope as defined by the appended claims.

1-7. (canceled)

8. A method for producing an organic fertilizer which enables an increased microbial diversity and abundance in soil, the method comprising:
composting fresh S. alopecuroides plants together with sheep and/or goat manure by making a heap thereof with a layer of the manure disposed on a layer of the plants and then moistening all layers with water and covering the heap with a polymeric film to allow for anaerobic fermentation in a sealed environment,
wherein, fermentation is determined to be completed when the following conditions are satisfied: a temperature of the heap decreases; odor from the manure, sulfur, and ammonia disappears; a scent peculiar to the S. alopecuroides plants is emitted; a colour of the heap becomes light and changes to brown; and leaves of the plants are degraded and remaining stalks are dark in colour and have soft and frangible fibers.

9. The method according to claim 8, wherein a mass ratio of the S. alopecuroides plants to the manure is 1000:300.

10. The method according to claim 8, wherein the anaerobic fermentation is carried out for 40 days.

11. A process for using organic fertilizer produced by a method comprising:
composting fresh S. alopecuroides plants together with sheep and/or goat manure by making a heap thereof with a layer of the manure disposed on a layer of the plants and then moistening all layers with water and covering the heap with a polymeric film to allow for anaerobic fermentation in a sealed environment,
wherein, fermentation is determined to be completed when the following conditions are satisfied: a temperature of the heap decreases; odor from the manure, sulfur, and ammonia disappears; a scent peculiar to the S. alopecuroides plants is emitted; a colour of the heap becomes light and changes to brown; and leaves of the plants are degraded and remaining stalks are dark in colour and have soft and frangible fibers;
increasing abundance of bacterial and fungal communities in the rhizosphere of a plant, comprising applying the organic fertilizer to a soil in which the plant is grown at the end of the flowering period of the plant.

12. The process according to claim 11, wherein a mass ratio of the S. alopecuroides plants to the manure is 1000:300.

13. The process according to claim 11, wherein the anaerobic fermentation is carried out for 40 days.

14. The process according to claim 11, wherein the bacterial community is selected from the group consisting of Saccharimonadales, Haliangium, Iamia, Pelomonas, Pedomicrobium, Gaiella, Rokubacteriales, Lysobacter, and Acinetobacter.

15. The process according to claim 12, wherein the bacterial community is selected from the group consisting of Saccharimonadales, Haliangium, Iamia, Pelomonas, Pedomicrobium, Gaiella, Rokubacteriales, Lysobacter, and Acinetobacter.

16. The process according to claim 13, wherein the bacterial community is selected from the group consisting of Saccharimonadales, Haliangium, Iamia, Pelomonas, Pedomicrobium, Gaiella, Rokubacteriales, Lysobacter, and Acinetobacter.

17. The process according to claim 11, wherein the fungal community is selected from the group consisting of Acremonium, Lophotrichus, Aspergillus, Mortierella, Botryotrichum, Pseudeurotium, Acaulium, Ilyonectria, Cutaneotrichosporon, and Talaromyces.

18. The process according to claim 12, wherein the fungal community is selected from the group consisting of Acremonium, Lophotrichus, Aspergillus, Mortierella, Botryotrichum, Pseudeurotium, Acaulium, Ilyonectria, Cutaneotrichosporon, and Talaromyces.

19. The process according to claim 13, wherein the fungal community is selected from the group consisting of Acremonium, Lophotrichus, Aspergillus, Mortierella, Botryotrichum, Pseudeurotium, Acaulium, Ilyonectria, Cutaneotrichosporon, and Talaromyces.

20. A process for using an organic fertilizer produced by a method comprising:
composting fresh S. alopecuroides plants together with sheep and/or goat manure by making a heap thereof with a layer of the manure disposed on a layer of the plants and then moistening all layers with water and covering the heap with a polymeric film to allow for anaerobic fermentation in a sealed environment,
wherein, fermentation is determined to be completed when the following conditions are satisfied: a temperature of the heap decreases; odor from the manure, sulfur, and ammonia disappears; a scent peculiar to the S. alopecuroides plants is emitted; a colour of the heap becomes light and changes to brown; and leaves of the plants are degraded and remaining stalks are dark in colour and have soft and frangible fibers;
increasing contents of soluble solids and sugar present in fruit of a melon plant, comprising application of the organic fertilizer to a soil in which the melon plant is grown at the end of the flowering period of the plant.

21. The process according to claim 20, wherein a mass ratio of the S. alopecuroides plants to the manure is 1000:300.

22. The process according to claim 20, wherein the anaerobic fermentation is carried out for 40 days.
